(19) United States
(12) Patent Application Publication
(10) Pub. No.: US 2003/0112219 A1
(43) Pub. Date: Jun. 19, 2003

(54) Input/output interface control

(76) Inventors: Imed Gharsalli, Peoria, IL (US); Daniel E. Shearer, Metamora, IL (US)

Correspondence Address: CATERPILLAR INC., 100 N.E. ADAMS STREET, PATENT DEPT., PEORIA, IL, 616296490

(21) Appl. No.: 10/092,333

(22) Filed: Mar. 6, 2002

Related U.S. Application Data
(60) Provisional application No. 60/341,561, filed on Dec. 14, 2001.

(51) Int. Cl. G09G 5/00

(52) U.S. Cl. 345/156

(57) ABSTRACT

A method and apparatus for controlling a parameter of at least one signal. The method and apparatus includes receiving a desired command signal from at least one control input, determining a potential condition for receiving an undesired command signal from at least one other control input, activating a desired command as a function of the desired command signal, and controlling a parameter of a signal from the at least one other control input in response to the potential condition.

This application claims the benefit of prior provisional patent application Serial No. 60/341,561, filed Dec. 14, 2002.

### TECHNICAL FIELD

This invention relates generally to a method and apparatus for controlling an output as a function of an input and, more particularly, to a method and apparatus for controlling a response characteristic of at least one output as a function of at least one input.

### BACKGROUND

Input devices, such as joysticks, levers, automated input functions and the like, are used in a wide variety of applications. For example, machines, such as work machines, often require several input devices to perform one or more of several control functions. As a specific example, work machines such as motor graders employ several control inputs to control the movement of a work tool, e.g., a grader blade, that is designed to move in multiple degrees of freedom.

Continuing efforts to reduce operator fatigue and increase productivity have resulted in the development of input devices which are more responsive to movement and require less effort to manipulate. In addition, some input devices have been incorporated into a single input control device, such as a joystick with multiple control functions. Although the developments in input devices have substantially improved operator control and response, the devices have also proved to be so sensitive to movement that it is common for undesired control functions to be actuated as the desired functions are implemented. For example, moving a joystick in one desired direction may cause the joystick to inadvertently move in one or more other directions as well, thus causing unwanted movement of the output device being controlled. At times, this unwanted movement can cause adverse effects, and actually contribute to reduced efficiency and productivity. The problem is made more complicated by noting that, even though many circumstances result in a desire to prevent inadvertent activation of certain control inputs during deliberate activation of one or more other control inputs, there are other circumstances in which non-activated control inputs must be kept available for quick activation. Therefore, any attempts to resolve the problem of inadvertent activation of some inputs must be done selectively.

The present invention is directed to overcoming one or more of the problems as set forth above.

### SUMMARY OF THE INVENTION

In one aspect of the present invention a method for controlling a parameter of at least one signal is disclosed. The method includes the steps of receiving a desired command signal from at least one control input, determining a potential condition for receiving an undesired command signal from at least one other control input, activating a desired command as a function of the desired command signal, and controlling a parameter of a signal from the at least one other control input in response to the potential condition.

In another aspect of the present invention an apparatus for controlling a parameter of at least one signal is disclosed. The apparatus includes a plurality of control inputs, and a controller for receiving a desired command signal from at least one control input, determining a potential condition for receiving an undesired command signal from at least one other control input, activating a desired command as a function of the desired command signal, and controlling a parameter of a signal from the at least one other control input in response to the potential condition.

### BRIEF DESCRIPTION OF THE DRAWINGS

FIG. 1 is a block diagram illustrating a preferred embodiment of the present invention; and

FIG. 2 is a flow diagram illustrating a preferred method of the present invention.

### DETAILED DESCRIPTION

Referring to the drawings and the appended claims, a method and apparatus 100 for controlling a parameter of at least one signal is shown.

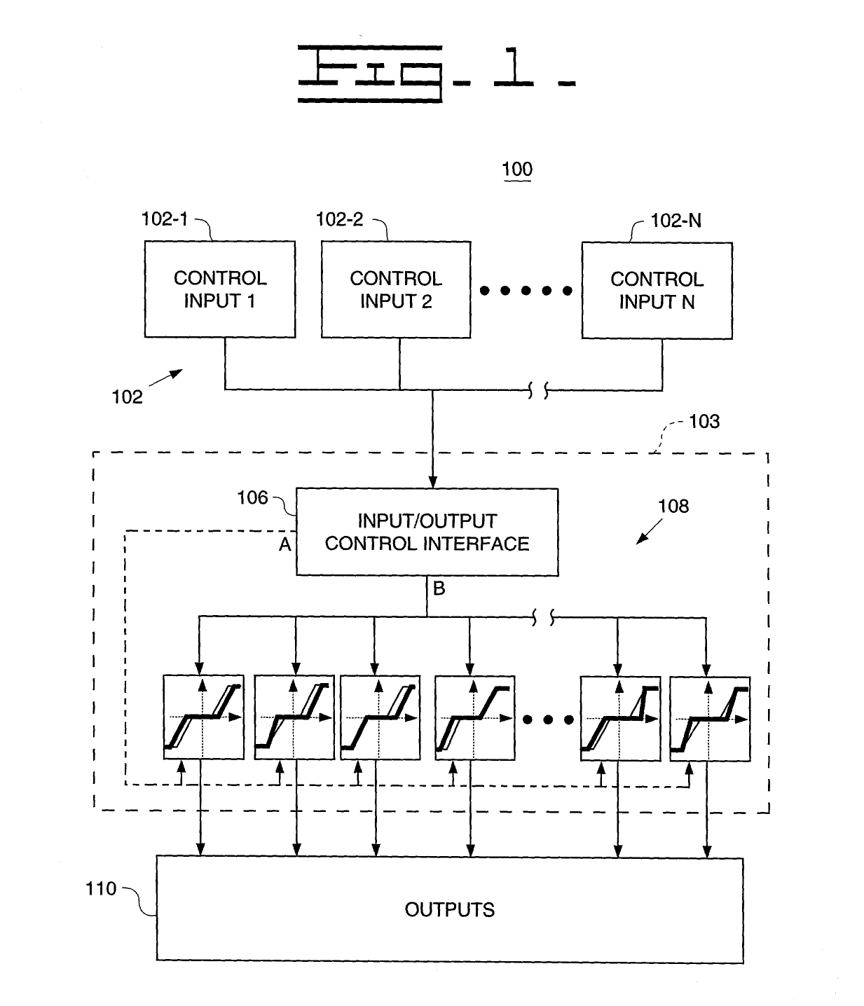

Referring to FIG. 1, a block diagram illustrating a preferred embodiment of the present invention is shown.

A plurality of control inputs 102 provides a means to input command signals for a wide variety of applications. The control inputs 102 may be one or more joysticks, levers, automated programs, and the like. For example, the control inputs 102 may be incorporated into a joystick (not shown) having a plurality of axes. Each axis of the joystick may be used to provide an associated control input. Joysticks having multiple axes are used extensively in many applications, such as work machines, wheelchairs and other devices for physically-impaired individuals, computer applications and games, and the like.

Another example of control inputs 102 include automated programs that are selected to perform certain tasks to increase speed, accuracy, efficiency, productivity and such. Typically, an automated program will operate until either the task is completed or is interrupted, such as by manual intervention via another control input 102. For example, an operator may be able to interrupt an automated function and return to manual mode by activating a manual control input, e.g., a joystick or lever.

One further example of control inputs 102 include devices known as proportional buttons, which include a category of control devices which increase an output signal in proportion to an amount of operator input, e.g., how far an operator pushes a button in. Proportional output devices are known in the art and will not be discussed further.

A controller 103 receives desired command signal from one or more control inputs 102. In the preferred embodiment, the controller 103 also determines if any potential conditions exist for receiving undesired command signals from one or more of the other control inputs 102. For example, the controller 103 may determine that one or more control inputs 102 may be inadvertently activated. The controller 103 proceeds to activate the desired command as a function of the desired command signal. The controller 103 further proceeds to control a parameter of a signal from one or more undesired control inputs 102 in response to determining that potential conditions for receiving undesired command signals exist.

For example, the controller 103 may receive a desired command signal from control input 1 and determine that a potential exists for receiving an undesired signal from control input 2, since control input 2 may easily be inadvertently activated during intentional activation of control input 1. The controller 103 then responsively controls a parameter of a signal from control input 2, as is described in more detail below.

In the preferred embodiment, the controller 103 includes an input/output control interface 106 for receiving signals from the control inputs 102, analyzing the signals, passing them through, and initiating commands for controlling parameters of the signals. The controller 103 also includes at least one control function 108. Preferably, the controller 103 includes a plurality of control functions 108, which may include deadband control, gain control, and any combination thereof. The control functions 108 may be determined from equations, look-up tables, or by some other method.

The desired command signal is then passed through to one or more outputs 110 to command the output 110 to perform some function. For example, the outputs 110 may include electrical actuators, electro-hydraulic actuators, and such, and may be used for various tasks, such as moving a device, e.g., a work tool, mobile machine, computer-generated icons, and the like. Any undesired command signals would be passed through an appropriate control function 108 to provide selective control of the signal. It is noted that an undesired control signal may be determined to be a desired control signal, such as after a predetermined time period has elapsed. In this circumstance, the controller 103 may remove the controlled parameter, i.e., the control function 108, from the command signal path.

Preferably, as shown in FIG. 1, the command signals from the control inputs 102 are passed through the input/output control interface 106 via path B, and all parameter control signals are delivered from the input/output control interface 106 via path A. However, it is noted that all signals, input and parameter control, may be delivered along a single path as well.

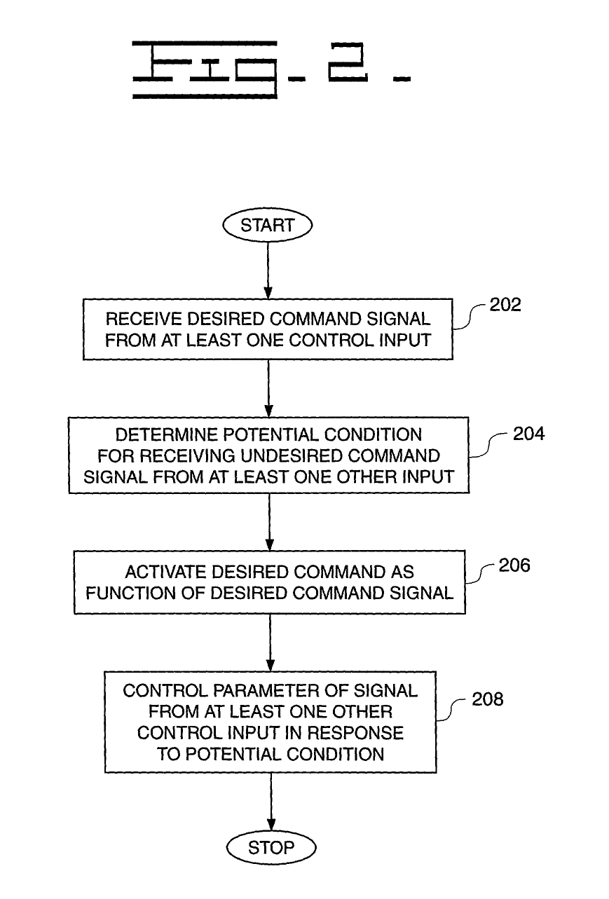

Referring to FIG. 2, a flow diagram illustrating a preferred method of the present invention is shown.

In a first control block 202, the controller 103 receives a desired command signal from at least one control input 102. The desired command signal may be delivered by a single control input 102 or may be a command signal determined by multiple control inputs 102. For example, two or more control inputs 102 may be activated to initiate a complex command, rather than one control input 102 being activated to initiate a single relatively simple command.

In a second control block 204, the controller 103 determines if a potential condition exists for receiving an undesired command from at least one other control input 102. For example, if a multiple control input desired command is received, the controller 103 may determine via equations, look-up tables and such that certain other commands received at that time would be undesirable.

In a third control block 206, the controller 103 activates the desired command as a function of the desired signal or signals received.

In a fourth control block 208, the controller 103 controls a parameter of a signal from the at least one other control input 102, i.e., the undesired command, in response to determining the existence of the potential condition. For example, the controller 103 may increase the deadband required to activate the undesired command to prevent inadvertent activation from bumping or accidently moving the undesired control input 102. As another example, the controller 103 may alter the gain and/or slope parameter of the control function 108 associated with the undesired control input 102 in order to provide further control to prevent inadvertent activation of the undesired command.

### INDUSTRIAL APPLICABILITY

As an example of an application of the present invention, multiple control inputs 102 may be incorporated into a single device, such as a joystick (not shown). Multiple-axis joysticks typically are designed with shorter throw distances and lighter efforts to move, thus reducing fatigue from continued use and improving efficiency. However, it is difficult to avoid making small, inadvertent movements of the joystick in directions other than desired. A small, inadvertent movement of a control input 102, such as a multiple-axis joystick, may result in a larger, unwanted movement of the output device being controlled. The present invention alleviates this problem by determining which movements of control inputs 102 may be undesired and changing command parameters, such as by increasing deadband or changing gain parameters thus filtering out inadvertent command activations.

Other aspects, objects, and features of the present invention can be obtained from a study of the drawings, the disclosure, and the appended claims.

What is claimed is:

1. A method for controlling a parameter of at least one signal, including the steps of:
receiving a desired command signal from at least one control input;
determining a potential condition for receiving an undesired command signal from at least one other control input;
activating a desired command as a function of the desired command signal; and
controlling a parameter of a signal from the at least one other control input in response to the potential condition.

2. A method, as set forth in claim 1, wherein receiving a desired command signal includes the step of receiving a desired command signal from at least one axis of a joystick.

3. A method, as set forth in claim 1, wherein receiving a desired command signal includes the step of receiving a desired command signal from at least one lever.

4. A method, as set forth in claim 1, wherein receiving a desired command signal includes the step of receiving a desired command signal from an automated program.

5. A method, as set forth in claim 1, wherein receiving a desired command signal includes the step of receiving a desired command signal from a proportional output device.

6. A method, as set forth in claim 1, wherein controlling a parameter of a signal includes the step of increasing an amount of deadband of the at least one other control input.

7. A method, as set forth in claim 1, wherein controlling a parameter of a signal includes the step of controlling a gain parameter of the at least one other control input.

8. An apparatus for controlling a parameter of at least one signal, comprising:
a plurality of control inputs; and
a controller for:
receiving a desired command signal from at least one control input;
determining a potential condition for receiving an undesired command signal from at least one other control input;
activating a desired command as a function of the desired command signal; and
controlling a parameter of a signal from the at least one other control input in response to the potential condition.

9. An apparatus, as set forth in claim 8, wherein the plurality of control inputs includes a joystick.

10. An apparatus, as set forth in claim 9, wherein the joystick includes a plurality of axes, each axis providing an associated control input.

11. An apparatus, as set forth in claim 8, wherein the plurality of control inputs includes at least one lever.

12. An apparatus, as set forth in claim 8, wherein the plurality of control inputs includes at least one automated program for initiating a command signal.

13. An apparatus, as set forth in claim 8, wherein the plurality of control inputs includes at least one proportional output device.

14. An apparatus, as set forth in claim 8, wherein the plurality of control inputs includes at least one of a joystick, a lever and an automated program.

15. An apparatus, as set forth in claim 8, wherein the controller includes:
an input/output control interface; and
at least one of a deadband control function and a gain control function.
